(19) United States
(12) Patent Application Publication
(10) Pub. No.: US 2007/0110924 A1
(43) Pub. Date: May 17, 2007

(54) Process for improving the color of gemstones and gemstone minerals obtained thereby

(76) Inventors: William B. Yelon, Columbia, MO (US); Jinbo Yang, Rolla, MO (US); William J. James, Rolla, MO (US)

Correspondence Address: HOVEY WILLIAMS LLP, Suite 400, 2405 Grand, Kansas City, MO, 64108, US

(21) Appl. No.: 11/273,475

(22) Filed: Nov. 14, 2005

(51) Int. Cl. B44F 7/00; B32B 9/00; B05D 3/02

(52) U.S. Cl. 428/15; 428/701; 427/248.1; 427/372.2; 427/314

(57) ABSTRACT

New methods of forming color-coated gemstones are provided. These methods broadly comprise subjecting a source of metal (e.g., an organometallic compound) to a vapor deposition process so as to form the metal source into a vapor that is subsequently deposited onto the surface of a previously heated gemstone. The vapor is also diffused into the gemstone so as to form a mixed zone of gemstone having the metal source dispersed or intermixed therein. The coated gemstone is then subjected to heat treatment to alter the valence state of the metal in the coating until the desired colored coating is obtained, resulting in coatings having superior adhesion and optical properties.

### BACKGROUND OF THE INVENTION

1. Field of the Invention

The present invention is broadly concerned with novel methods for forming a color coating on gemstones using vapor deposition techniques.

2. Description of the Prior Art

Topaz is a popular gemstone often used to form jewelry. The topaz stone is initially colorless, and must be treated to form a colored stone. Topaz contains impurities that are colorless unless treated, and in one common process, the stone is irradiated to cause the impurities to change colors. The type of irradiation affects the colors that are obtained. For example, if the stones are electron irradiated, the resulting stone color will be pale blue. If the stones are neutron irradiated, the resulting color will be a strong blue with a grayish cast. Irradiating stones has many drawbacks, including the fact that it is dangerous, the equipment utilized is costly, and the quality achieved is highly variable. Furthermore, the stones must be shipped to different locations depending upon the stage of the process, and a fair percentage of the inventory is damaged during shipping.

Attempts have been made to apply a colored coating to stones in order to avoid the drawbacks of the irradiation process. However, the coating processes thus far have been lacking as well. For example, many of the coatings presently used have unacceptable color variation or suffer from optical interference in the coating (e.g., the color variation in the coating resembles the color variations observed in a pool of oil). Furthermore, these coatings may not adhere well to the stone. That is, the coatings can be easily scratched and flaked from the stone.

There is a need for a reliable, safe, and cost-effective stone coating process that produces stones having coatings that are uniform in color and adhere well to the stones.

### SUMMARY OF THE INVENTION

The present invention overcomes these problems by broadly novel methods of coating stones.

In more detail, the inventive methods comprise coating a stone by subjecting it to a vapor deposition process (e.g., chemical vapor deposition (CVD), physical vapor deposition (PVD)). The stone or gemstone to be coated is preferably first cleaned using any method that results in a clean surface. A preferred cleaning method involves washing the stone with a solvent (e.g., alcohol, acetone) and then rinsing with distilled water to remove any surface residue.

The clean stones are dried or allowed to air-dry and placed (preferably face-down) on a heating plate or other suitable heating means within a CVD or PVD reactor. The stones are then heated to a temperature of at least about 250° C., more preferably from about 250-400° C., and even more preferably from about 275-375° C. The stone is preferably maintained at this temperature until the precursor is introduced into the reactor and for the duration of the coating step as described below. This time period is typically from about 10-30 minutes. While the stones are being heated, the reactor is evacuated to a pressure of less than about 30 mTorr, preferably from about 1-20 mTorr, and even more preferably from about 1-5 mTorr.

A precursor compound (preferably an organometallic compound or other metal source) may be introduced into the reactor in several different ways, depending upon the precursor. For compounds with a high vapor pressure at room temperature (e.g., Fe(CO)₅), the compound may be introduced from an external source through an inlet, without heating. For compounds with a lower vapor pressure at room temperature, the compound may be introduced either by heating an external reservoir containing the precursor to vaporize the precursor and then introducing the vapors through an inlet, or by heating a reservoir of the precursor that has previously been positioned inside the reactor. This is accomplished by heating the precursor to a temperature of from about 50-250° C., preferably from about 50-150° C., and even more preferably from about 50-100° C.

The desirable flow rate of the precursor through a reactor with volume of 1 liter (regardless of the means of introduction) is preferably in the range of from about 5-25 sccm, and more preferably from about 10-20 sccm. While the precursor is flowing through the reactor, the pressure is preferably from about 0.1-20 Torr, and more preferably from about 0.1-10 Torr. Preferably, a temperature gradient is created within the reactor, with the highest temperature being at the entry port. The vapor will flow towards the lower temperature outlet, coating the stones with metal or metal oxide as it passes. A suitable temperature gradient would result in the outlet having a temperature of from about 10-50° C. lower than the temperature at the entry port. Optionally, an inert carrier gas (e.g., N₂, Ar, He) may be used to entrain the precursor vapors inside the reactor in order to transport the precursor past the heated stones and out of the system.

The deposition step is preferably carried out for a time period of from about 1-60 minutes, and more preferably from about 1-5 minutes. Optionally, another precursor stream comprising silanes, aluminum alcoholates, and/or magnesium oxide, for example, could be introduced simultaneous to the metal or organometallic precursor introduction to yield a wider range of unique colors. Also, two or more precursor compounds could be mixed together and introduced using the methods described above.

After the deposition step, the chamber is evacuated and cooled to room temperature. At this stage, the coating on the stones will typically have a dark black color or metallic appearance due to the presence of a metallic film on the stones. In some cases, the stones will need no further treatment as the desired color will be achieved. In other applications, however, a change in the color of the coating can be effected by then heating (in the same reactor or in a different reactor such as a tube furnace) the stones, at ambient pressure, at a temperature of less than about 550° C., preferably from about 250-550° C., and even more preferably from about 300-400° C. This heating step is preferably carried out for a time period of less than about 10 minutes, and more preferably from about 3-8 minutes, and in the presence of an oxidizing agent (e.g., air, pure oxygen). Color change is accomplished because the heating step results in a change in the valence of the metal in the coating. It will be appreciated that the heating temperatures and times can be adjusted, depending upon the final target color.

The entire process could be repeated after turning the stones over, if desired. However, this is often unnecessary because even with a coating on only one side, the color will appear to be present throughout the stone. Also, any conventional vapor deposition equipment can be used to carry out the foregoing process so long as the aforementioned pressures and temperatures can be achieved by that equipment.

As far as the materials needed to carry out the inventive methods are concerned, preferred stones include those selected from the group consisting of topaz, quartz, ruby, emerald, and sapphire, however, it will be appreciated that any gemstone or semi-precious stone could be utilized.

It is preferred that the metal source (e.g., pure metal or the metallic portion of the organometallic compound) comprise a metal selected from the group consisting of the transition metals of the Periodic Table, with the most preferred metals being those selected from the group consisting of chromium, iron, cobalt, titanium, copper, nickel, manganese, and mixtures thereof. Of course, the metal or metal oxide layer deposited on the stone surface will also comprise these preferred metals.

When an organometallic precursor is utilized, it should be selected so that the organometallic precursor will initially form a vapor when introduced into the reactor, without the organic portion decomposing. The organic portion of the organometallic precursor should instead be one that will decompose upon contact with the heated stones (typically at a temperature of from about 250-350° C.). The most preferred organic moieties are those comprising at least one carbonyl group, and preferably at least 2 or 3 carbonyl groups, per mole of organometallic precursor compound. The metallic portion of the organometallic moiety is preferably selected from the group consisting of Al and the transition metals of the Period Table. The most preferred organometallic precursor compounds include those selected from the group consisting of Fe(CO)₅, CO₂(CO)₈, Mn₂(CO)₁₀, Cr(CO)₆, Ti(C₃H₇O)₄, and Al[OCH(CH₃)₂]₃. For precursors streams comprising a mixture of precursor compounds, the ratio of metallic moieties in the mixture can be adjusted to provide a range of colors.

In another embodiment, the source of metal comprises an oxide selected from the group consisting of oxides of Al, Mg, Si, and mixtures thereof, with the oxide being doped with an element selected from the group consisting of the first and second row transition metals and elements of the lanthanide series. The doped oxide should comprise only small amounts of dopant, preferably less than about 3% by weight dopant, and even more preferably less than about 1% by weight dopant, based upon the total weight of the doped oxide taken as 100% by weight. As used herein, “doping” means that some quantity of the Al, Mg, and/or Si in the oxide has been replaced with the dopant. One example of this embodiment would be Al₂O₃ doped with Cr to produce a ruby-colored coating, where some of the Al would be replaced with Cr. Advantageously, this embodiment provides another avenue for forming a wide variety of colored coatings.

It will be appreciated that practicing the foregoing method results in novel, color-coated stones having superior properties over prior art color-coated stones. For example, the color achieved in the inventive stones will be uniform and free of color variation or optical interference. Furthermore, the coating will have superior adhesion to the stone. When the coating is rubbed with a material with a Knoop hardness less than that of the coating, for example using a polishing cloth, no change is observed in the thickness or other characteristics of the coating. When the coating is rubbed with a material with a higher Knoop hardness, e.g. diamond paper, the coating will be thinned by erosion, but will not be seen to separate from the stone as a distinct flake or particle.

In part, this superior adhesion is achieved due to the fact that the coating material partially diffuses into, or is dispersed within, the outer portions of the stone. That is, some of the atoms of the stone are replaced with atoms from the coating. Referring to FIG. 1, there will be a coating layer 10 on the outer surface of the stone 12 that will typically have an average (over 5 measurements) thickness of at least about 20 nm, and preferably at least about 50 nm. This thickness can be adjusted (typically over a range of from about 20-1,000 nm), depending upon the desired coating color.

Advantageously, this thickness will be substantially uniform over a given surface of the stone so that the thinnest point “t” is within about 5% of the thickness of the thickest point “T” of the coating. It is acceptable, however, for different faces of the stone 12 to have different coating thicknesses as may occur when, for example, the upper side of the stone girdle is partially shadowed from the precursor stream.

The stone 12 has a core or central portion 14 that comprises pure stone (i.e., stone that has not been modified physically or chemically by the inventive process). The stone 12 also includes a mixed zone 16 that has been modified by the inventive process. That is, during the inventive process, the precursor compound and or coating layer is caused to diffuse into the stone creating the zone 16 that is chemically and/or physically different from the core or central portion 14. That is, the coating layer 10 is dispersed in, or intermixed with, the stone 12 to form the zone 16.

The mixed zone 16 is bound by outer boundary 18 and inner boundary 20. The concentration of unmodified stone in the zone 16 will increase as the distance to the inner boundary 20 decreases (i.e., as the distance from the outer boundary 18 increases). Stated another way, the concentration of coating material in zone 16 will increase as the distance to outer boundary 18 decreases (i.e., as the distance from the inner boundary 20 increases). That is, there is a compositional gradient across the thickness of zone 16, and there is no sharp interface at which the chemical composition and physical properties (including color, hardness, crystal structure, etc.) abruptly change. For clarity, as used herein, outer boundary 18 is the boundary at which the make-up of zone 16 comprises about 95% by atomic concentration of metal (on a total metal basis) of coating layer 10. Inner boundary 20 is the boundary at which the make-up of zone 16 comprises about 95% by atomic concentration metal (on a total metal basis) of core or central portion 14 (i.e., unmodified stone).

The average (over 5 measurements) thickness of zone 16 will be at least about 20 nm, preferably at least about 50 nm, and even more preferably from about 50-200 nm.

The thickness is measure be determining the distance between the inner and outer boundaries 18, 20 as defined above.

### BRIEF DESCRIPTION OF THE DRAWING FIGURES

FIG. 1 is a sectional view illustrating the different layers of a gemstone coated according to the present invention.

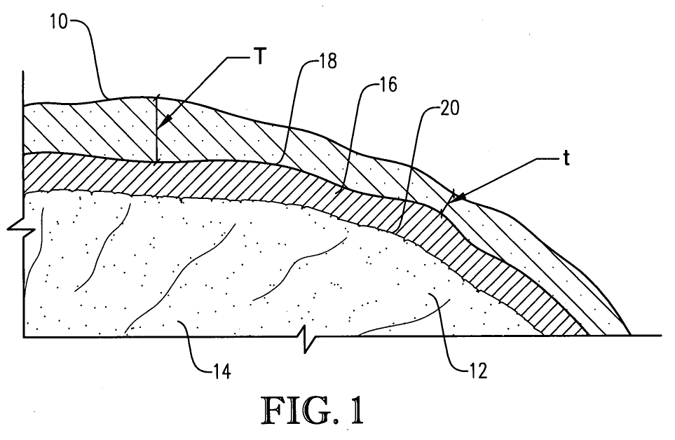

### DETAILED DESCRIPTION OF THE PREFERRED EMBODIMENTS

### Examples

The following examples set forth preferred methods in accordance with the invention. It is to be understood, however, that these examples are provided by way of illustration and nothing therein should be taken as a limitation upon the overall scope of the invention.

### Example 1

### Preparation of Color-Coated Stones Using Fe(CO)₅ Precursor

Topaz stones were cleaned with acetone, washed with distilled water, and air-dried. The stones were then placed face down on the top of a heating plate and transferred to a cylindrical glass reactor. The system was evacuated to approximately 10 mTorr, and the heating plate and the stones on the heating plate were heated to a temperature of about 300° C. The pump was stopped, and Fe(CO)₅ precursor was then introduced into the reactor at a rate of about 15 sccm to begin the deposition process. Deposition was continued for about 3 minutes at which time the precursor introduction was halted. The chamber was evacuated and cooled to room temperature. At this stage in the process, a gray or black coating was observed on the stones. The coated stones were then taken out of the reactor and put into a tube furnace. The furnace temperature was maintained at about 400° C. for about 5 minutes while air was circulated through the tube. The stones were cooled to room temperature, and those with the thickest coatings exhibited a reddish-orange color, while those with the thinnest coatings exhibited a predominantly yellow color. The stones with thicknesses approximately midway between the thinnest and thickest coatings exhibited an attractive amber color.

The thicknesses of the coatings (including the mixed zone) on the stones ranged from about 100 nm for the stones having the thinnest coatings, to about 400 nm for the stones having the thickest coatings. The amber stones had a thickness of about 200 nm. The thickness of the mixed zone of the stones averaged about 140 nm.

### Example 2

### Analysis of Mixed Zone of Color-Coated Stone

One of the amber stones prepared in Example 1 was selected for analysis. An amber stone was selected because it represented the approximate mid-point in color and coating thickness of the coated stones.

The surface and near-surface regions of the stone were analyzed using Auger electron spectroscopy to determine its chemical composition as a function of depth. These results are given in Table 1. The top 50 nm were found to primarily comprise Fe and O, but some Si and Al appears to have left the original stone surface and “back-diffused” into the surface layer. The C seen at the very top was an artifact of preparation of the sample for the Auger apparatus.

Between 50 nm and approximately 180 nm, the concentration of Fe decreased steadily, while the Si and Al concentrations increased. These depths defined the diffused layer, or mixed zone of the stone, in which the coating materials are fully chemically bonded to the stone surface, thereby creating a permanent, durable, colored region that is also bonded to the surface layer. These results show that the stone surface has been permanently modified by the coating process, thereby creating a novel material.

TABLE 1

| nm^{A} | % Si^{B} | % Al | % Fe | % F | % O | % C | % S |
|---|---|---|---|---|---|---|---|
| 0 | 4.7 | 2.5 | 18.5 | 0 | 49.1 | 24.9 | 0.4 |
| 6.5 | 14.1 | 6.1 | 26 | 0 | 53.8 | 0 | 0 |
| 13 | 9.4 | 5 | 33.1 | 0 | 52.5 | 0 | 0 |
| 19.5 | 5.7 | 2.6 | 31.5 | 0 | 58.7 | 1.4 | 0 |
| 26 | 5.5 | 3.1 | 31.3 | 0 | 59.1 | 1 | 0 |
| 32.5 | 7.8 | 2.6 | 31.8 | 0 | 56.4 | 1.3 | 0 |
| 39 | 5.4 | 3.5 | 34.6 | 0 | 55.1 | 1.5 | 0 |
| 52 | 7.9 | 9.6 | 33.8 | 0 | 46.9 | 1.8 | 0 |
| 65 | 13.8 | 17.4 | 21 | 0 | 45.8 | 2 | 0 |
| 78 | 17.6 | 22.6 | 9.9 | 0 | 48.6 | 1.4 | 0 |
| 97.5 | 21.1 | 31.1 | 3.2 | 3.3 | 39.5 | 1.9 | 0 |
| 117 | 24.8 | 29.4 | 4.1 | 2.1 | 36.9 | 2.7 | 0 |
| 136.5 | 26.1 | 31.8 | 3.5 | 1.7 | 34 | 2.9 | 0 |
| 156 | 22.2 | 32.2 | 3.7 | 2.5 | 37.8 | 1.6 | 0 |
| 175.5 | 29.7 | 28.1 | 3.5 | 2.1 | 35.1 | 1.7 | 0 |
| 195 | 23.5 | 26.1 | 2.9 | 3.2 | 42.1 | 2.2 | 0 |
| 214.5 | 13.9 | 33.3 | 3 | 3.2 | 45 | 1.7 | 0 |
| 234 | 22.6 | 27.5 | 2.8 | 2.9 | 42.8 | 1.3 | 0 |
| 253.5 | 21.7 | 28 | 2.6 | 2.9 | 43.4 | 1.4 | 0 |
| 273 | 16.7 | 26.8 | 2.3 | 3.8 | 48.8 | 1.6 | 0 |
| 292.5 | 18 | 25.8 | 1.7 | 3.7 | 49.4 | 1.3 | 0 |
| 312 | 14.2 | 28 | 1.5 | 4 | 50.5 | 1.9 | 0 |
| 331.5 | 17.5 | 28.7 | 2.3 | 3.4 | 46.4 | 1.7 | 0 |
| 351 | 15.6 | 27.9 | 2.2 | 3.8 | 48.9 | 1.6 | 0 |
| 370.5 | 17.4 | 27.9 | 1.8 | 3.5 | 48.3 | 1.1 | 0 |
| 390 | 21.3 | 26.6 | 3.2 | 3.1 | 44.5 | 1.4 | 0 |

^{A}Distance from outer surface of coating on the gemstone.
^{B}All percentages are given as atomic concentration of the designated atoms, with the percentages being based upon the total atomic concentrations of all identified atoms at the given depth taken as 100%. Deviations from 100% represent rounding errors in reporting. Minor impurities have been ignored

### Example 3

### Preparation of Color-Coated Stones Using CO₂(CO)₈ Precursor

Topaz stones were cleaned with acetone, washed with distilled water, and air-dried. The stones were then placed face down on the top of a heating plate and transferred to a cylindrical glass reactor. A cobalt precursor, CO₂(CO)₈, was loaded into the reactor chamber in an open glass container. The entire system was evacuated to approximately 10 mTorr before the deposition process was commenced. The heating plate and the stones on the heating plate were heated to a temperature of about 350° C. After the plate reached the desired temperature, the entire chamber was heated to about 150° C. with a heating tape to volatilize the Co precursor, and deposition was commenced. The deposition time was about 5 minutes. The heat plate and heating tape were then turned off, and the chamber was evacuated and cooled to room temperature. At this stage in the process, a silver or metallic coating was observed on the stones. The coated stones were then taken out of the reactor and put into a tube furnace. The heat temperature was maintained at about 450° C. for about 10 minutes while air was circulated through the tube. The stones were cooled to room temperature, and they exhibited colors ranging from light green to dark green, depending upon the coating thickness. The thicknesses of the coatings on the stones ranged from about 100 nm for the stones having the thinnest coatings, to about 350 nm for the stones having the thickest coatings.

The deposition time for this process can be varied to be from about 5-30 minutes, depending upon the desired coating thickness. Also, the subsequent heat treatment can be carried out at temperature ranges of from about 300-1,000° C., for times ranging from about 1-60 minutes. Or, if a light blue to a dark blue or green-blue mixed color is desired, it can be obtained using a heat treatment of about 1,000-1,100° C. in air for a time period of from about 10 minutes to about 3 hours.

### Example 4

### Preparation of Color-Coated Stones Using Mn₂(CO)₁₀ Precursor

Topaz stones were cleaned with acetone, washed with distilled water, and air-dried. The stones were then placed face down on the top of a heating plate and transferred to a cylindrical glass reactor. The system was evacuated to approximately 10 mTorr before the deposition process was commenced, and the heating plate and the stones on the heating plate were heated to a temperature of about 350° C. After the plate reached the desired temperature, the entire chamber was heated to about 150° C. with a heating tape. The Mn precursor, Mn₂(CO)₁₀, was then introduced into the reactor at a rate of about 10 sccm to begin the deposition process. Deposition was continued for about 5 minutes at which time the precursor introduction was halted, and the power to the heaters was removed. The chamber was evacuated and cooled to room temperature. At this stage in the process, a gray or metallic coating was observed on the stones. The coated stones were then taken out of the reactor and put into a tube furnace. The furnace temperature was maintained at about 450° C. for about 15 minutes while air was circulated through the tube. The stones were cooled to room temperature, and they exhibited colors ranging from light orange to dark orange, depending upon the coating thickness. The thicknesses of the coatings on the stones ranged from about 100 nm for the light orange stones, to about 400 nm for the dark orange stones.

The deposition time for this process can be varied to be from about 1-30 minutes, depending upon the desired coating thickness. Also, the subsequent heat treatment can be carried out at temperature ranges of from about 300-700° C., for times ranging from about 1-60 minutes.

### Example 5

### Preparation of Color-Coated Stones Using Ti(C₃H₇O)₄ Precursor

The procedure in Example 4 was repeated as described above, except that a Ti precursor, Ti(C₃H₇O)₄, was used instead of the Mn precursor. After cooling the reactor to room temperature, the stones exhibited a metallic coating. Some stones were subjected to heat treatment below about 500° C., resulting in a semi-opaque, light blue or dark blue color, depending upon film thickness. The thicknesses of the coatings on the stones ranged from about 50 nm for the light blue stones, to about 200 nm for the dark blue stones.

Other stones were subjected to heat treatment at temperatures of from about 500-700° C., resulting in a light violet color coating on the stones having a thickness of about 100 m.

### Example 6

### Preparation of Color-Coated Stones Using Cr and Al Precursors

The procedure in Example 3 was repeated as described above, except that a precursor comprising a mixture of Cr and Al (at a Cr:Al molar ratio of 1:1) was used instead of the Mn precursor. After cooling the reactor to room temperature, the stones exhibited a dark blue or light green to dark green color coating without additional heat treatment. The green stones remained transparent or semi-transparent while the bluish stones were nearly opaque. The thicknesses of the coatings on the stones ranged from about 50-200 nm.

The green color changed to a golden or golden-orange color after heat treatment at about 450° C. in air for about 15 minutes. This heat treatment could be carried out at temperatures of from about 300-700° C. and for a time period of from about 1-30 minutes.

We claim:

1. A method of forming a coated stone, said method comprising the steps of:
providing a stone having a surface to be coated;
subjecting a quantity of a source of metal to a vapor deposition process so as to deposit a coating comprising said metal on said surface, said metal having an initial valence; and
heating said coating at a temperature of less than about 550° C. so as to change said initial valence and form the coated stone.

2. The method of claim 1, wherein said stone is selected from the group consisting of topaz, quartz, ruby, emerald, and sapphire.

3. The method of claim 1, further comprising the step of heating said stone to a temperature of at least about 250° C. prior to said subjecting step, during said subjecting step, or prior to and during said subjecting step.

4. The method of claim 1, wherein said metal is selected from the group consisting of the transition metals of the Periodic Table.

5. The method of claim 4, wherein said metal is selected from the group consisting of chromium, iron, cobalt, titanium, copper, nickel, manganese, and mixtures thereof.

6. The method of claim 1, wherein said source of metal comprises an organometallic compound having an organic portion and a metallic portion, said metallic portion comprising a metal selected from the group consisting of Al and the transition metals of the Periodic Table.

7. The method of claim 1, wherein said source of metal comprises an organometallic compound having an organic portion and a metallic portion, said organic portion being thermally decomposable upon contact with a surface having a temperature of from about 250-350° C.

8. The method of claim 7, wherein said organic portion comprises at least one carbonyl group per mole of organometallic compound.

9. The method of claim 6, wherein said organometallic compound is selected from the group consisting of Fe(CO)₅, CO₂(CO)₈, Mn₂(CO)₁₀, Cr(CO)₆, Ti(C₃H₇O)₄, and Al[OCH(CH₃)₂]₃.

10. The method of claim 1, wherein said source of metal comprises an oxide selected from the group consisting of oxides of Al, Mg, Si, and mixtures thereof, said oxide doped with an element selected from the group consisting of first and second row transition metals and elements of the lanthanide series of the Periodic Table.

11. The method of claim 1, wherein said heating step comprises heating said coating to a temperature of from about 250-550° C.

12. The method of claim 1, wherein said heating step is carried out in the presence of an oxidizing agent for a sufficient time to form a coating having a target color.

13. The method of claim 1, wherein said coating has a thickness on top of the surface of at least about 20 nm.

14. The method of claim 1, wherein said coated stone comprises a zone comprising a physical mixture of the stone and the coating.

15. The method of claim 1, wherein said coated stone comprises a zone comprising the reaction product of said coating diffused into said stone.

16. A method of forming a coated stone, said method comprising the steps of:
providing a stone having a surface to be coated;
heating said stone to a temperature of at least about 250° C.; and
subjecting a quantity of a source of metal to a vapor deposition process so as to deposit a coating comprising said metal on said surface and form the coated stone.

17. The method of claim 16, wherein said stone is selected from the group consisting of topaz, quartz, ruby, emerald, and sapphire.

18. The method of claim 16, wherein said metal is selected from the group consisting of the transition metals of the Periodic Table.

19. The method of claim 18, wherein said metal is selected from the group consisting of chromium, iron, cobalt, titanium, copper, nickel, manganese, and mixtures thereof.

20. The method of claim 16, wherein said source of metal comprises an organometallic compound having an organic portion and a metallic portion, said metallic portion comprising a metal selected from the group consisting of Al and the transition metals of the Periodic Table.

21. The method of claim 16, wherein said source of metal comprises an organometallic compound having an organic portion and a metallic portion, said organic portion being thermally decomposable upon contact with a surface having a temperature of from about 250-350° C.

22. The method of claim 21, wherein said organic portion comprises at least one carbonyl group per mole of organometallic compound.

23. The method of claim 20, wherein said organometallic compound is selected from the group consisting of Fe(CO)₅, CO₂(CO)₈, Mn₂(CO)₁₀, Cr(CO)₆, Ti(C₃H₇O)₄, and Al[OCH(CH₃)₂]₃.

24. The method of claim 16, wherein said source of metal comprises an oxide selected from the group consisting of oxides of Al, Mg, Si, and mixtures thereof, said oxide doped with an element selected from the group consisting of first and second row transition metals and elements of the lanthanide series of the Periodic Table.

25. The method of claim 16, wherein said heating step comprises heating said coating to a temperature of from about 250-400° C.

26. The method of claim 16, wherein said coating has a thickness on top of the surface of at least about 20 nm.

27. The method of claim 16, wherein said coated stone comprises a zone comprising a physical mixture of the stone and the coating.

28. The method of claim 16, wherein said coated stone comprises a zone comprising the reaction product of said coating diffused into said stone.

29. A coated stone comprising:
a stone having a core:
a zone having an outer surface and surrounding at least a portion of said core; and
a colored coating on said outer surface, said zone:
comprising said stone intermixed with said coating; and
having a thickness defined as the distance from said outer surface to said core, said thickness being at least about 20 nm.

30. The stone of claim 29, wherein said colored coating on said outer surface has a thickness of at least about 20 nm.

31. The stone of claim 29, wherein said stone is selected from the group consisting of topaz, quartz, ruby, emerald, and sapphire.

32. The stone of claim 29, wherein said colored coating on said outer surface comprises a metal.

33. The stone of claim 32, wherein said metal is present in a metal oxide selected from the group consisting of iron oxide, cobalt oxide, chromium oxide, manganese oxide, magnesium oxide, copper oxide, nickel oxide, titanium oxide, aluminum oxide, silicon oxide, and mixtures thereof.

34. The stone of claim 29, wherein said zone comprises a physical mixture of the stone and the coating.

35. The stone of claim 29, wherein said zone comprises the reaction product of the coating diffused into the stone.
